(19) United States
(12) Patent Application Publication
(10) Pub. No.: US 2026/0252474 A1
(43) Pub. Date: Aug. 27, 2026

(54) PERFORMANCE INDICATORS OF A SOFTWARE DEVELOPMENT ENVIRONMENT

(71) Applicant: Codium Ltd., Tel-Aviv (IL)

(72) Inventors: Itamar FRIDMAN, Ramat Gan (IL); Gadi ZIMERMAN, Hod-HaSharon (IL)

(73) Assignee: Codium Ltd., Tel-Aviv (IL)

(21) Appl. No.: 19/062,208

(22) Filed: Feb. 25, 2025

(51) Int. Cl. G06F 11/3668; G06F 11/32

(52) U.S. Cl. CPC G06F 11/3692; G06F 11/323; G06F 11/3684

(57) ABSTRACT

There is provided a method comprising: extracting a performance indicator(s) from a software development environment, obtaining context of the software development environment, in response to the performance indicator(s) not meeting a corresponding guideline(s): automatically generating, by a planning agent, a plan for improving the performance indicator(s) based on the context, automatically selecting an implementation agent(s) based on the plan, generating a prompt for instructing the implementation agent(s) for automatic generation for improvement of the performance indicator(s) according to the plan, the prompt includes the context, feeding the prompt into the implementation agent(s), obtaining data elements generated by the implementation agent(s) in response to the prompt, and applying the data elements to the software development environment to generate an adapted software development environment, wherein the adapted software development environment improves software development efficiency by narrowing a gap with or meeting the corresponding guideline(s), and/or changing a trend of the performance indicator(s).

### BACKGROUND

The present invention, in some embodiments thereof, relates to a software development environment and, more specifically, but not exclusively, to systems and methods for improving performance of the software development environment.

Tools for improving software development have been developed, for example, for enhancing productivity, collaboration, code quality, and project management.

### SUMMARY

According to a first aspect, a computer-implemented method of automatically improving software development efficiency, comprising using at least one processor for: accessing a software development environment in a process of developing software, extracting at least one performance indicator from the software development environment, wherein the at least one performance indicator comprises measurable metrics related to software development efficiency, obtaining context of the software development environment, analyzing the at least one performance indicator with respect to a corresponding at least one guideline stored on a data storage device, in response to the at least one performance indicator not meeting the corresponding at least one guideline: automatically generating, by a machine learning based planning agent selected from a plurality of specialized planning agents according to the at least one performance indicator, a plan for improving the at least one performance indicator based on the context, automatically selecting at least one machine learning based implementation agent from a plurality of specialized machine learning based implementation agents based on the plan, generating a prompt for instructing the selected at least one implementation agent for automatic generation for improvement of the at least one performance indicator according to the plan, wherein the prompt includes the context, feeding the prompt into the selected at least one implementation agent, obtaining data elements generated by the selected at least one implementation agent in response to the prompt, and applying the data elements generated by the selected at least one machine learning based implementation agent to the software development environment to generate an adapted software development environment, wherein the adapted software development environment with at least one adapted performance indicator improves software development efficiency by narrowing a gap with or meeting the corresponding at least one guideline, and/or changing a trend of the at least one performance indicator.

According to a second aspect, a system for automated support of software development, comprising: at least one hardware processor executing a code for: accessing a software development environment in a process of developing software, extracting at least one performance indicator from the software development environment, obtaining context of the software development environment, analyzing the at least one performance indicator with respect to a corresponding at least one guideline, in response to the at least one performance indicator not meeting the corresponding at least one guideline: automatically generating a plan for improving the at least one performance indicator according to the context by a planning agent selected from a plurality of planning agents according to the at least one performance indicator, automatically selecting at least one implementation agent from a plurality of implementation agents based on the plan, generating a prompt for instructing the selected at least one implementation agent for automatic generation for improvement of the at least one performance indicator according to the plan, wherein the prompt includes the context, feeding the prompt into the selected at least one implementation agent, obtaining data elements generated by the selected at least one implementation agent, and applying the data elements generated by the selected at least one implementation agent to the software development environment to generate an adapted software development environment with at least one adapted performance indicator for narrowing a gap with or meeting the corresponding at least one guideline.

According to a third aspect, a non-transitory medium storing program instructions for automated support of software development, which when executed by at least one processor, cause the at least one processor to: access a software development environment in a process of developing software, extract at least one performance indicator from the software development environment, obtain context of the software development environment, analyze the at least one performance indicator with respect to a corresponding at least one guideline, in response to the at least one performance indicator not meeting the corresponding at least one guideline: automatically generating a plan for improving the at least one performance indicator according to the context by an planning agent selected from a plurality of planning agents according to the at least one performance indicator, automatically selecting at least one implementation agent from a plurality of implementation agents based on the plan, generating a prompt for instructing the selected at least one implementation agent for automatic generation for improvement of the at least one performance indicator according to the plan, wherein the prompt includes the context, feeding the prompt into the selected at least one implementation agent, obtaining data elements generated by the selected at least one implementation agent, and apply the data elements generated by the selected at least one implementation agent to the software development environment to generate an adapted software development environment with at least one adapted performance indicator for narrowing a gap with or meeting the corresponding at least one guideline.

In a further implementation form of the first, second, and third aspects, further comprising re-executing the extracting and the analyzing for obtaining an adapted at least one performance indicator from the adapted software development environment, and evaluating whether the adapted at least one performance indicator extracted from the adapted software development environment narrowed the gap and/or meets the at least one guideline, and/or a trend of the at least one performance indicator is changed.

In a further implementation form of the first, second, and third aspects, further comprising iterating the extracting, the analyzing, the in response, and the applying, until the at least one adapted performance indicator meets the corresponding at least one guideline, or converges, or another preset condition is met.

In a further implementation form of the first, second, and third aspects, the at least one performance indicator includes a percentage of code coverage by a code test, the plan is for increasing code coverage above a threshold defined by the at least one guideline, and the at least one implementation agent is trained for automatically generating code tests for increasing the percentage of code coverage.

In a further implementation form of the first, second, and third aspects, the at least one performance indicator includes a number of bugs detected per time interval, the plan is for reducing the number of bugs below a threshold defined by the at least one guideline, and the at least one implementation agent is trained for automatically reviewing code and/or for automatically improving code and/or for generating instructions for presenting to developers instructing how to review code and/or how to improve the code.

In a further implementation form of the first, second, and third aspects, the at least one performance indicator includes deployment frequency of successful releases of a software product to production, the plan is for increasing the deployment frequency above a threshold, and the at least one implementation agent is trained for automatically implementing and/or configuring continuous integration/development (CI/CD) tools.

In a further implementation form of the first, second, and third aspects, the at least one performance indicator includes a mean lead time for changes (MLT) indicating a time from code commit to production, the plan is for decreasing the MLT below a threshold, and the at least one implementation agent is trained for setting up automated code review for decreasing MLT from pull request to code merge.

In a further implementation form of the first, second, and third aspects, the software development environment is hosted by a computing environment, and includes at least one of: written code, automatically generated code, test plans, version control tools and ci/cd tools, specification, and output logs.

In a further implementation form of the first, second, and third aspects, further comprising: obtaining a plurality of the at least one performance indicator over a historical time interval, predicting whether the at least one performance indicator will not meet the at least one guideline in the future based on a trend analysis of the plurality of the at least one performance indicator over the historical time interval, and wherein the plan is for at least one of: improving the prediction of the at least one performance indicator for meeting the at least one guideline in the future.

In a further implementation form of the first, second, and third aspects, further comprising: generating a graphical user interface (GUI) for presentation on a display, the GUI presenting at least one of: the at least one performance indicator, the corresponding at least one guideline, and a visual indication of whether the at least one guideline is met by the at least one performance indicator, the GUI further including an interactive element for triggering the automatic execution of the plan using the selected at least one implementation agent.

In a further implementation form of the first, second, and third aspects, in response to the at least one performance indicator not meeting or improving the corresponding at least one guideline, presenting an offer to assist the user by adapting the plan and/or iterating the plan and implementation thereof, and the GUI further includes at least one second interactive element to enable the user to trigger the adaptation of the plan and/or iteration of the plan and implementation thereof.

In a further implementation form of the first, second, and third aspects, further comprising for each respective planning agent of the plurality of planning agents, presenting at least one of: at least one adoption metric indicating adoption of the respective planning agent by users, and/or at least one return on investment (ROI) indicator indicating savings and/or reductions due to adoption of the respective planning agent in comparison to non-adoption of the respective planning agent.

In a further implementation form of the first, second, and third aspects, the at least one performance indicator includes key development metrics indicating development efficiency and/or quality, comprising at least one of: DORA (DevOps Research and Assessment) metrics, code coverage, defect rates, and cycle time.

In a further implementation form of the first, second, and third aspects, automatically generating the plan comprises automatically generating at least one plan for improving the at least one performance indicator, and further comprising: presenting the at least one automatically generated plan on a display within a GUI, wherein the GUI includes at least one interactive element for enabling a user to select the plan from the at least one automatically generated plan, wherein the plan is selected by the user using the at least one interactive element.

In a further implementation form of the first, second, and third aspects, at least one of: (1) wherein each respective implementation agent is associated with a first tag indicating at least one performance indicator that the respective implementation agent generates data elements for improvement thereof, the first tag used for selecting the implementation agent, and (2) wherein each respective planning agent is associated with a second tag indicating at least one performance indicator that the respective planning agent may generate a plan for improvement of, the second tag used for selecting the planning agent.

In a further implementation form of the first, second, and third aspects, at least one of: (1) wherein each planning agent is associated with a respective set of tools and/or resources designed to perform specific tasks for generating a plan for a corresponding performance indicator, and (2) wherein each implementation agent is associated with a respective set of tools and/or resources designed to perform specific tasks for generating data elements for improving the corresponding performance indicator.

In a further implementation form of the first, second, and third aspects, further comprising: extracting a plurality of features from the software development environment, determining a cause-effect relationship between changes to the plurality of features and impact on the at least one performance indicator, predicting the changes to the plurality of features for closing a gap between the at least one performance indicator and the at least one guideline according to the cause-effect relationship, and selecting the planning agent and/or at least one implementation agent predicted to change the plurality of features for closing the gap.

In a further implementation form of the first, second, and third aspects, the planning agent and the at least one implementation agent are implemented as a single combined agent, that automatically generates data elements predicted to improve the at least one performance indicator when implemented in the software development environment, in response to a prompt instructing the single combined agent to improve the at least one performance indicator.

In a further implementation form of the first, second, and third aspects, the at least one implementation agent and/or the planning agent automatically retrieves context of the software development environment according to the at least one performance indicator and/or according to the prompt.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for automatic improvement of at least one performance indicator of a software development environment developing software, in accordance with some embodiments of the present invention;

FIG. 2 is a flowchart of a method of automatic improvement of at least one performance indicator of a software development environment developing software, in accordance with some embodiments of the present invention;

FIG. 3 is a dataflow diagram of a method of automatic improvement of at least one performance indicator of a software development environment developing software, in accordance with some embodiments of the present invention; and

FIG. 4 is a schematic of an exemplary GUI for assisting with automatic improvement of at least one performance indicator of a software development environment developing software, in accordance with some embodiments of the present invention.

### DETAILED DESCRIPTION

The present invention, in some embodiments thereof, relates to a software development environment and, more specifically, but not exclusively, to systems and methods for improving performance of the software development environment, optionally for automatically improving software development efficiency and/or improving a trait of software development.

An aspect of some embodiments of the present invention relates to systems, methods, computing devices, and/or code instructions (stored on a data storage device and executable by one or more processors) for automated support of software development. A software development environment in a process of developing software is provided (e.g., accessed). One or more performance indicators are extracted from the software development environment, for example, one or more metrics, quality metrics, and the like. Context of the software development environment may be obtained. The performance indicator is analyzed with respect to a corresponding guideline, such as for determining whether the performance indicator meets the corresponding guideline or does not meet the corresponding guideline. In response to the performance indicator not meeting the corresponding guideline, a plan for improving the performance indicator may be automatically generated. The performance indicator may be implemented in a format, for example, a list of numbers, a visual graph, and the like. The plan may represent a high level outline, such as written in standard text to be understandable to a human. The plan may be automatically generated by one or more planning agents, which may be selected from multiple available planning agents. The selection of the planning agent(s) may be according to the performance indicator, such as where different planning agents are designed to improve different performance indicators. The plan may be automatically generated by the planning agent(s), by generating a prompt based on the performance indicator, and feeding the prompt to the planning agent. The plan may be generated in view of the context. Alternatively or additionally, the planning agent(s) may be pre-set to generate a plan for a predefined performance indicator. Optionally, an implementation agent(s) is selected based on the plan. Alternatively, the features described herein with reference to the implementation agent(s) are implemented by the planning agent(s). The implementation agent(s) may be selected from different designed implementation agents, where each implementation agent may be for a different type of plan, such as based on different performance indicators, and the like. A prompt may be generated for instructing the selected implementation agent(s) for automatic generation for improvement of the performance indicator(s) according to the plan. The prompt may include the context and/or be generated in view of the context. The prompt is fed into the selected implementation agent(s). Data elements generated by the selected implementation agent(s) are obtained. The data elements may represent a more specific set of instructions for implementing the higher level plan. The data elements may be, for example, values of parameters for configuring the software development environment, instructions for execution by one or more other processes, instructions for presenting to developers (or other users of the software development environment), and the like. The data elements generated by the selected implementation agent(s) are implemented (e.g., executed) by the software development environment to generate an adapted software development environment. An adapted performance indicator(s) is determined for the adapted software development environment. The adapted performance indicator(s) is predicted to narrow a gap with, or to meet, the corresponding guideline, in comparison to the original (or preceding) performance indicator(s). Alternatively or additionally, the adapted performance indicator(s) is predicted to change a trend of the performance indicator(s), for example, from a negative trend to a positive trend. The aforementioned features may be dynamically iterated until convergence is reached (without necessarily meeting the guideline) and/or until the corresponding guideline is met and/or until another present condition is met.

At least one embodiment described herein addresses the technical problem of improving performance of a software development environment, for improving quality of software generated using the software development environment. In particular the technical problem may relate to improving one or more performance indicators of the software development environment. At least one embodiment described herein improves the technical field of tools for software development, for improving performance of a software development environment, for improving quality of software generated using the software development environment. At least one embodiment described herein improves upon prior approaches of software development using a software development environment. At least one embodiment described herein provides the practical application of improving performance of a software development environment, for improving quality of software generated using the software development environment.

Users (e.g., R&D managers) may often face challenges in understanding the direct impact and/or contribution of development tools used within the software development lifecycle. Even when these tools' roles are understood, users (e.g., managers) are not always aware of the available options to improve monitored performance indicators and/or how to effectively implement changes to improve the performance indicators. This disconnect may often result in reduced engagement, difficulty in evaluating the tools' return on investment (ROI), and/or missed opportunities to improve overall productivity.

In many cases, actionable insights regarding tool adoption, ROI, and/or productivity improvements are either not accessible or fail to translate into practical steps for addressing performance gaps. Without a clear understanding of how to select and apply improvements, users (e.g., R&D managers) are unable to make data-driven decisions, thereby reducing the potential for meaningful optimization.

At least one embodiment described herein presents actionable insights, suggests actionable plans for improving development performance indicators, executes these plans, and/or measures their impact. At least one embodiment described herein may enable users (e.g., R&D managers) to better recognize the contributions of development tools, improve their utilization, and/or optimize team performance. Furthermore, enforcing organizational best practices—such as code quality standards, code coverage thresholds, or productivity metrics—often requires significant manual oversight. At least one embodiment described herein that automatically performs these processes may alleviate managerial burden and/or may ensure that developers adhere to optimal workflows while focusing on high-impact tasks.

One or more potential advantages of one or more embodiments described herein include:
Enhancing team productivity by automating adherence to best practices.
Improving development performance indicators such as code coverage, bug detection rates, and feature delivery speed.
Driving better ROI on development tools by optimizing their usage and measuring their contributions.
Reducing managerial workload through automated planning and execution.

At least one embodiment described herein provides a solution to the aforementioned technical problem, and/or improves the aforementioned technical field, and/or improves the aforementioned existing approaches, and/or provides the aforementioned practical application, by automatically generating a plan for improving a performance indicator that does not meet a corresponding guideline using an planning agent, which may be selected from multiple available planning agents. The plan may be automatically generated by the planning agent, by generating a prompt based on the performance indicator, and feeding the prompt to the planning agent. Optionally, an implementation agent is selected based on the plan. The implementation agent may be selected from different designed implementation agents, where each implementation may be for a different type of plan, such as based on different performance indicators, and the like. A prompt may be generated for instructing the selected implementation agent for automatic generation for improvement of the performance indicator(s) according to the plan. The prompt is fed into the selected implementation agent. Data elements generated by the selected implementation agent are obtained. The data elements generated by the selected implementation agent are implemented (e.g., executed) by the software development environment to generate an adapted software development environment. An adapted performance indicator(s) is determined for the adapted software development environment. The adapted performance indicator(s) is predicted to narrow a gap with, or to meet, the corresponding guideline, in comparison to the original (or preceding) performance indicator(s). Alternatively or additionally, the adapted performance indicator(s) is predicted to change a trend of the performance indicator(s), for example, from a negative trend to a positive trend.

At least one embodiment described herein provide the practical application of automated improvement to a software development environment, in particular improvement of a performance indicator(s) of the software development environment, by adapting the software development environment based on output of a selected implementation agent fed a prompt instructing implementation of a plan for improvement of performance indicator(s), where the plan is automatically generated by a planning agent. The automatically adapted software development environment is predicted to improve the performance indicator(s).

At least one embodiment described herein combines automated decision-making, optionally user involvement, and/or adaptive optimization to improve performance indicators systematically. By integrating data, metadata, and/or intelligent planning with iterative execution, the guidelines (e.g., goals) may be met efficiently and/or effectively.

At least one embodiment described herein relates to: Ingesting and/or processing performance indicators and/or relevant contextual data (i.e., context), generating tailored improvement plans by considering available agents and their capabilities, optionally presenting the plan on a display to users for review and/or modification, executing the approved plan by orchestrating selected agents to act on the targeted metrics, and measuring the impact of executed plans on performance metrics and/or iterating the aforementioned process for continuous improvement.

At least one embodiment described herein is designed to provide users (e.g., R&D managers) with actionable insights and/or an automated framework for improving the software development processes, which is predicted to drive higher productivity, better ROI on tools, and/or adherence to organizational standards.

Some potential advantages of at least one embodiment described herein include:
Optimizing task assignments to align with team goals and/or organizational standards.
Reducing manual oversight by automating the execution of improvement plans.
Ensuring adherence to best practices through structured workflows.
Continuously measuring the impact of executed plans and/or incorporating feedback for subsequent iterations.
Ensuring incremental improvement over time, and/or adapting to evolving organizational needs.
Providing users (e.g., R&D managers) with clear, data-driven insights into tool contributions and actionable steps for improvement.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

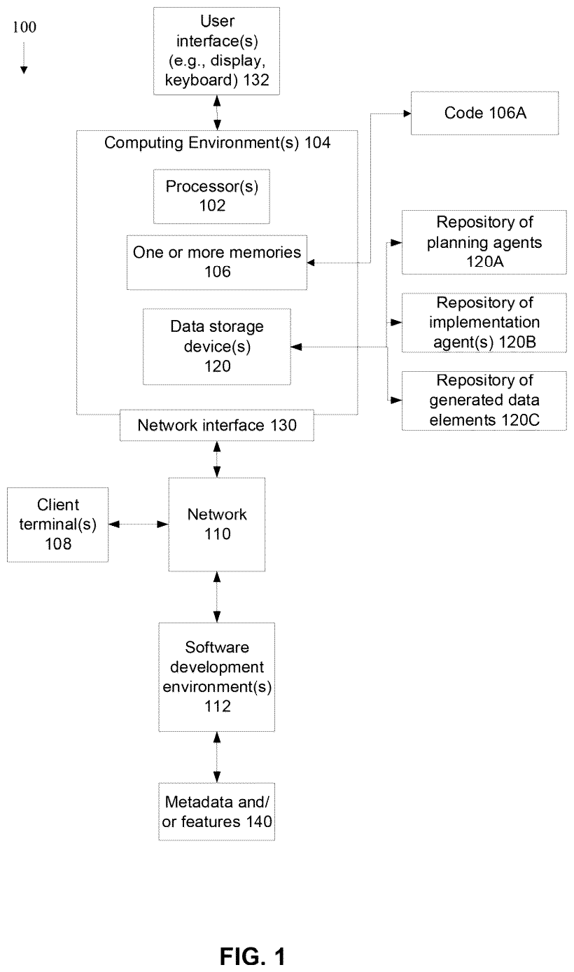

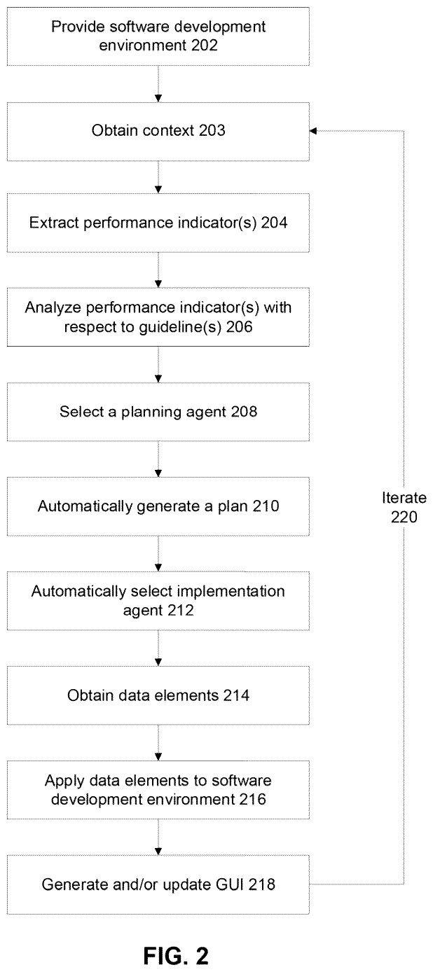

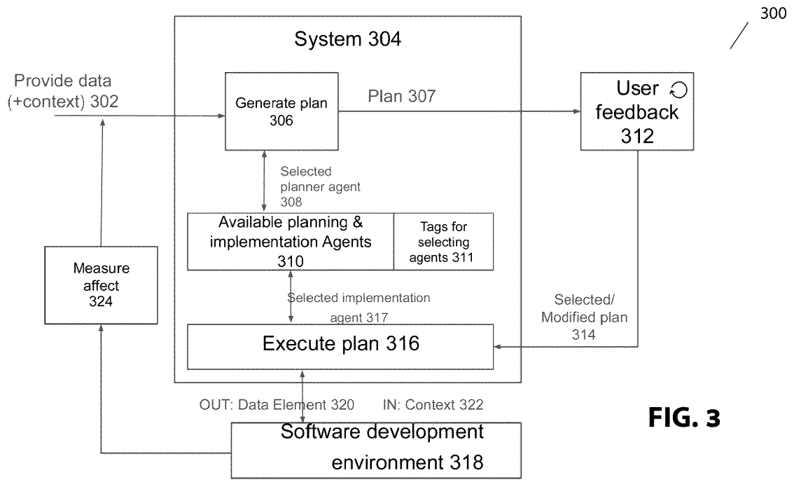

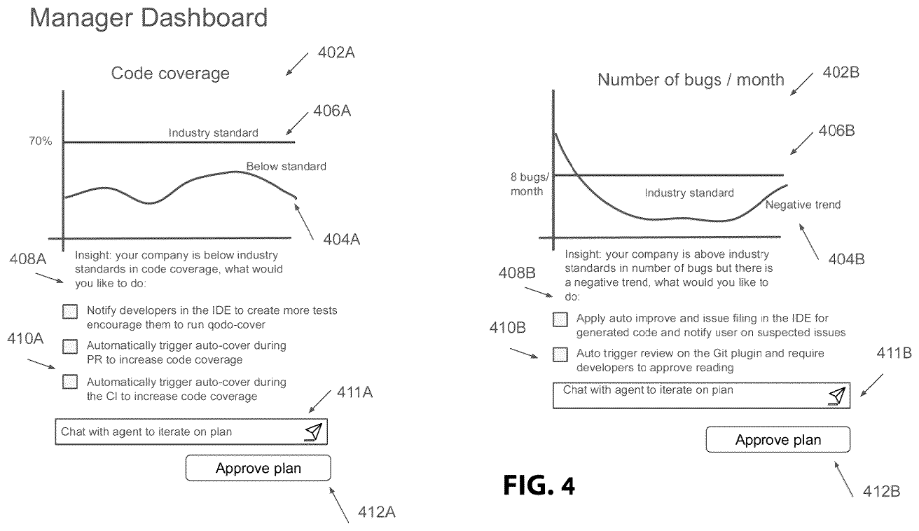

Reference is now made to FIG. 1, which is a block diagram of components of a system for automatic improvement of at least one performance indicator of a software development environment developing software, in accordance with some embodiments of the present invention. Reference is also made to FIG. 2, which is a flowchart of a method of automatic improvement of at least one performance indicator of a software development environment developing software, in accordance with some embodiments of the present invention. Reference is also made to FIG. 3, which is a dataflow diagram 300 of a method of automatic improvement of at least one performance indicator of a software development environment developing software, in accordance with some embodiments of the present invention. Reference is also made to FIG. 4, which is a schematic of an exemplary GUI 402A-B for assisting with automatic improvement of at least one performance indicator of a software development environment developing software, in accordance with some embodiments of the present invention.

Referring now back to FIG. 1, a system 100 may implement the acts of the method described, for example with reference to FIGS. 2-4, by processor(s) 102 of a computing environment 104 executing code instructions 106A stored in a memory 106 (also referred to as a program store).

Computing environment monitors performance of one or more software development environments 112, such as by extracting metadata and/or features and/or other data 140, and computing one or more performance indicators from the metadata 140. A plan for improvement may be generated and/or selected, for example, from a repository of planning agents 120A, optionally one or more machine learning models. One or more implementation agents, optionally from a repository of implementation agents 120B, automatically generated elements for implementing the plan. The generated elements may be stored in a repository of generated data elements 120C. The generated elements may be implemented in the software development environment(s) 112, based on the prediction of an improvement in the performance indicators.

Computing environment 104 may be implemented as, for example one or more and/or combination of: a computing cloud, a group of connected devices, a server, a virtual server, an administrative server, a network component (e.g., router, access manager, firewall), a client terminal, a virtual machine, a desktop computer, a thin client, a network node, and/or a mobile device (e.g., a Smartphone, a Tablet computer, a laptop computer, a wearable computer, glasses computer, and a watch computer).

Software development environment 112 may be implemented as, for example, within computing environment 104 such as by code executed by processor(s) 120 of computing environment 104, hosted by another server where client terminals 108 access software development environment 112, and/or locally run by another computing device such as a client terminal 108.

Multiple architectures of system 100 based on computing environment 104 may be implemented. For example:
Computing environment 104 executing stored code instructions 106A, may be implemented as one or more servers (e.g., network server, web server, a computing cloud, and a virtual server) that provides centralized services (e.g., one or more of the acts described with reference to FIGS. 2-4). Services may be provided, for example, to one or more software development environments 112 over network 110, and/or to one or more client terminals 108 which may access software development environment 112 over network 110. Services may be provided to software development environment 112(s) and/or client terminal(s) 108, for example, as software as a service (SaaS), a software interface (e.g., application programming interface (API), software development kit (SDK)), an application for local download to the software development environment 112(s) and/or client terminal(s) 108, an add-on to a web browser running on software development environment 112(s) and/or client terminal(s) 108, and/or providing functions using a remote access session to the software development environment 112(s) and/or client terminals 108, such as through a web browser executed by software development environment 112(s) and/or client terminal 108 accessing a web sited hosted by computing environment 104. For example, performance indicators 150 are provided from one or more software development environment 112(s) and/or client terminal 108 accessing software development environment 112(s) and/or to computing environment 104. Computing environment 104 centrally computes performance indicators from the metadata, generates a plan based on the performance indicators, and/or generates elements for implementing the plan, as described herein. The generated elements may be provided back to the corresponding software development environment 112(s) for implementation therein, which may provide the predicted improvement.
Computing environment 104 may be implemented for local execution (i.e., include locally stored code instructions 106A) of one or more of the acts described with reference to FIGS. 2-4, for locally monitoring performance of software development environment 112(s) and/or for improving performance of software development environment 112(s), by generation of a plan, generation of elements, and implementation of the elements, as described herein. Computing environment 104 may be integrated with software development environment 112(s), for example, the software development environment 112(s) is hosted and/or executed by computing environment 104. The locally stored code instructions 106A may be obtained from a server, for example, by downloading the code over the network, and/or loading the code from a portable storage device.

Processor(s) 102 of computing environment 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described, for example with reference to FIGS. 2-4, when executed by processor(s) 102.

Computing environment 104 may include a data storage device 120 for storing data, for example, a repository of planning agents 120A (e.g., machine learning models) for generating plans for improvement of the software development environment 112(s) based on one more performance indicators, a repository of implementation agents (e.g., machine learning models) 120B for generating data elements according to the plan, a repository of the generated data elements 120C for being implemented by the software development environment 112(s) for obtaining a predicted improvement, and/or other code processes, as described herein. Data storage device 120 may be implemented as, for example, a memory, a local hard-drive, virtual storage, a removable storage unit, an optical disk, a storage device, and/or as a remote server and/or computing cloud (e.g., accessed using a network connection).

Computing environment 104 may include a network interface 130 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 110 may be implemented as, for example, the internet, a local area network, a virtual network, a wireless network, a cellular network, a local bus, a point to point link (e.g., wired), and/or combinations of the aforementioned.

Computing environment 104 and/or client terminals 108 and/or software development environment 112(s) may include and/or may be in communication with one or more physical user interfaces 132 that include a mechanism for a user to enter data and/or view data. Exemplary user interfaces 132 include, for example, one or more of, a touchscreen, a display, a virtual reality display (e.g., headset), gesture activation devices, a keyboard, a mouse, and voice activated software using speakers and microphone.

Referring now back to FIG. 2, at 202, a software development environment in a process of developing software is provided and/or accessed. The software development environment may be hosted by a computing environment. The computing environment may be provided and/or accessed. The software development environment may include one or more of the following components which may be provided and/or accessed: written code, automatically generated code, test plans, version control tools (e.g., git, etc . . . ), continuous integration/continuous deployment (CI/CD) tools, specification (e.g., for writing the code), and output logs (e.g., outcomes of test results, compiler logs).

At 203, context of the software development environment may be obtained, for example, collected by a collection process.

It is noted that context may be obtained at one or more features described with reference to FIG. 2, and/or may be obtained by different processes, and/or used in different ways, for example, additional features described herein may include context.

Alternatively or additionally, the implementation agent(s) and/or the planning agent(s) may automatically retrieve context of the software development environment, for example, according to the prompt and/or according to the performance indicator(s). The retrieved context may be selected according to the prompt and/or according to the performance indicator(s) to enable the implementation agent to generate the data elements accordingly and/or to enable the planning agent to generate the plan accordingly. For example, the implementation agent and/or planning agent may be prompted to increase test coverage. The context of the software development environment may be obtained for increasing test coverage, for example, the code to test, existing tests, and the like.

The context may be retrieved based on a generation question answering (RAG) model. The RAG model may obtain the context in view of the prompt to for the implementation agent(s) and/or in view of the performance indicator(s) being provided to the planning agent(s).

The context (i.e., contextual) data of the software development environment may include parameters and/or constraints, for example, information about the environment, tools, and/or user interactions that can help optimize workflows, debugging, and automation. Example of context include:
System & Environment Data: operating system and version, available memory and CPU usage, network connectivity status, and system timezone and locale.
Development Tools & Configurations: programming language and version, frameworks and libraries in use, code editor/IDE settings, compiler or interpreter settings, and Debugger configurations.
Project & Repository Information: active branch in version control, recent commit history, open pull requests or merge conflicts, dependency versions and package managers, and build and deployment settings.
Developer Activity & Behavior: most frequently edited files, time spent on coding vs. debugging, commonly used shortcuts or commands, recent errors encountered, code review comments and feedback history.
Team & Collaboration Context: assigned tasks or issues, active slack or teams conversations, code ownership and recent contributors, and scheduled meetings or standups.
Runtime & Execution Data: recent logs and error messages, API request and response times, test coverage and results, and active database connections.
Security & Compliance Context: access control and authentication status, dependency vulnerability reports, and encryption and data privacy settings.

At 204, one or more performance indicators are extracted from the software development environment.

The performance indicator(s) may include measurable metrics related to software development efficiency

The performance indicators may be computed based on and/or from metadata associated with the software development environment. The metadata may be extracted from data sources associated with the software development environment. The metadata may be obtained and/or computed, for example, by one or more agents that may monitor the software development environment and/or extract data from the software development environment. The metadata may provide contextual information (i.e., context). Examples of metadata include: goals (e.g., organizational, team), industry standards, thresholds (e.g., organizational, team-specific), historical data and/or historical trends, market data, operational constrains, and the like.

The performance indicators may be implemented as, for example, numerical values, measurements, computed values, categorical values, ranges, text descriptions, in the form of a prompt for feeding into a planning agent, a chart (e.g., visual chart), and the like.

The performance indicators may include metrics, for example, (key) development metrics indicating development efficiency and/or quality such as DORA (DevOps Research and Assessment) metrics, code coverage, defect rates, and cycle time.

Optionally, one or more additional features are extracted from the software development environment, for example, the code itself, the number of lines of code, programming language, operating system, kernels, running environment, and the like. The additional features may provide context for the performance indicators, and/or may be used for determining a cause-effect relationship between the impacts of changes to the additional features on the performance indicators.

At 206, the performance indicator(s) is analyzed with respect to a corresponding guideline(s), for example, a goal, a target, a best practice standard, regulatory guidelines, and the like.

The analysis may be performed to determine whether the performance indicator meets the corresponding guideline(s) or does not meet the corresponding guideline(s). For example, the performance indicator may be a numerical value, the guideline may be a threshold or range, and the analysis may be to determine whether the numerical value is above or below the threshold, or within or external to the range.

Optionally, the performance indicator(s) are obtained over a historical time interval, for example, multiple values of the performance indicator(s) are obtained at different times over the historical time interval, for example, once a day for a week, once a week for a year, and the like. The analysis may include predicting whether the performance indicator(s) will not meet or will not meet the guideline(s) in the future. The prediction may be performed based on a trend analysis of the performance indicator(s) over the historical time interval, for example, fitting a trend line and/or curve to the values of the performance indicator(s) over the historical time interval, training a machine learning model using the performance indicator(s) obtained over the historical time interval, and the like.

At 208, a planning agent (e.g., a machine learning based planning agent) may be selected from multiple planning agents (e.g., multiple specialized machine learning based planning agents). The planning agent may be selected according to the performance indicator. For example, each planning agent is designed to generate a plan for a different performance indicator and/or combination of performance indicators.

Optionally, each respective planning agent is associated with a tag indicating one or more performance indicators that the respective planning agent may generate plans for improvement thereof. The tag may be used for automatic selection of the planning agent.

Optionally, each respective planning agent is associated with a respective set of tools and/or resources, designed to be used by the respective planning agent for performing one or more specific tasks (e.g., gathering data) for generating a plan, such as for its respective performance indicator(s). Examples of tools include: ability to access a network (e.g., internet), ability to use an indexed code base, ability to generate human readable content (e.g., text), for increasing test coverage, for identifying bugs in code, for managing pull requests, and for interacting with and/or alerting developers (and/or other users).

Examples of planning agents for generating plans for improving different performance indicators include:
For the performance indicator (e.g., within a prompt) “repositories should not include proprietary code”, the planning agent is provided with access to search the internet.
For the performance indicator (e.g., within a prompt) “percentage of documented code”, the planning agent may be provided with the ability to generate text from code.
For the performance indicator (e.g., within a prompt) “find bugs”, the planning agent may be provided with the ability to compare specification versus implementation and may be trained on different data.
For the performance indicator (e.g., within a prompt) “code coverage is below a threshold”, the planning agent may generate a plan for automated testing and/or suggest high-priority areas for text coverage improvement.

The selection may be based on one or more of: the performance indicator to improve, the metadata, the tag, the additional features extracted from the software development environment, the available planning agents, the set of tools, and/or other data.

The selection may be based on a cause-effect relationship, between changes to the additional features and impact on the performance indicator. A prediction of whether changes to the additional features close the gap with the guideline, provide no impact on the gap with the guideline, or increase the gap with the guideline, may be made according to the cause-effect relationship. Alternatively or additionally, the predictor is for whether the adapted performance indicator(s) will change a trend of the performance indicator(s), for example, from a negative trend to a positive trend. Planning agents and/or implementation agents that are predicted to change the additional features for closing the gap may be selected.

The selection may be done automatically, for example, by looking up the performance indicator within the tag. The planning agent corresponding to the tag that includes the performance indicator and/or features extracted from the software development environment, may be selected. In another example, the planning agent may be selected by a set of rules, such as applied against the performance indicator and/or features extracted from the software development environment. In yet another example, the selection may be done by a trained model (e.g., agent) that is fed the performance indicator and/or extracted features and/or tag, such as by generating and feeding the following prompt into the trained model “Find me a suitable planning agent to generate a plan for improving the performance indicator [insert] of the software development environment with the following features [insert] from the set of available planning agents found in [insert].”

The planning agent may be implemented as, for example, a generative artificial intelligence (GenAI) model, a machine learning model, a neural network, a large language model, and the like.

The planning agent may be trained on a training dataset of records. A record may include a sample performance indicator(s) and a ground truth of a sample plan for improvement of the sample performance indictor(s). The record may further include impact on the sample performance indicator obtained by applying the sample plan to the software development environment. The sample performance indicator and/or the sample plan may be obtained by collecting data from real data of the software development environment, and/or by collecting data by running simulations on the software development environment. The software development environment from which data is collected for training may be the same as the current software development environment which is being improved, and/or on a similar software development environment.

At 210, a plan may be generated by the selected planning agent.

The plan may be for improving the performance indicator(s), without necessarily meeting the corresponding guideline. The plan may be for meeting (e.g., exceeding) the corresponding guideline. The plan may be for improving the prediction of the performance indicator for meeting (e.g., exceeding) the guideline in the future, for example, without specifying a timeframe, and/or within a defined timeframe such as in a week, month, year, and the like. The plan may be a context-aware plan.

The plan may be structured, optionally defined by a template and/or predefined structure and/or predefined format. Alternatively, the plan does not necessarily follow a predefined structure, for example, the planning agent is not confined to the predefined structure but granted freedom in the way the plan is provided.

Optionally, the plan is implemented using human readable text. The plan may be presented at a high level, such as for enabling a user to determine whether the plan is suitable or not. The plan may exclude specific instructions for execution.

The plan may be generated by generating a prompt, and feeding the prompt to the planning agent. For example, when the performance indicator includes improvement of code coverage above a threshold defined by the guideline, the prompt may be “Generate a plan for improving code coverage about the threshold”.

Alternatively or additionally, the plan may be automatically generated by triggering execution of the selected planning agent. The planning agent may be pre-set to collect predefined inputs and automatically generate the plan for the performance indicator associated with the selected planning agent, without requiring an explicit prompt.

Optionally, other data may be extracted from the software development and used for generation of the plan, such as fed into the selected planning agent. The other data may be based on the performance indicator(s), and/or according to the configuration of the selected planning agent (e.g., what the selected planning agent requires as input in order to generate the plan).

At 212, an implementation agent (e.g., machine learning based implementation agent) or combination of implementation agents (e.g., multiple specialized machine learning based implementation agents) may be selected from multiple available implementation agents. The implementation agent may be selected based on the plan and/or based on the performance indicator(s). In the case of a combination of multiple implementation agents, the multiple agents may coordinate and/or orchestrate actions between themselves. Alternatively, a coordination module operates the multiple agents. For example, different implementation agents may be selected for generating data elements for different components of the software development environment.

Optionally, each respective implementation agent is associated with a tag indicating a respective type of plan that the respective implementation agent may generate instructions for implementation, and/or at least one performance indicator that the respective implementation agent may generate instructions for improving. The tag may be used for selecting the implementation agent. The tag associated with the implementation agent may be different than the tag associated with the planning agent. Alternatively a common tag is used, for example, a mapping dataset, where the tag is associated with pointers to the implementation agent and to the planning agent.

It is to be understood that the tag is an exemplary and not necessarily limiting implementation, and other data structures may be used, for example, key value pairs, a mapping dataset where each element of an index is associated with pointers to the implementation agent and/or to the planning agent, and the like.

Optionally, each respective implementation agent is associated with a respective set of tools and/or resources, designed to be used by the respective implementation agent for performing a specific task (e.g., gathering data) for generating data elements for implementing the plan, such as for improving a respective performance indicator(s). Examples of tools include: ability to access a network (e.g., internet), ability to use an indexed code base, ability to generate human readable content (e.g., text), for increasing test coverage, for identifying bugs in code, for managing pull requests, and for interacting with and/or alerting developers (and/or other users).

The selection may be based on one or more of: the performance indicator to improve, the metadata, the additional features extracted from the software development environment, the available planning agents, the set of tools, and/or other data.

Examples of implementation agents for generating data elements for improving different performance indicators include:
For the plan (e.g., within a prompt) “make sure repositories don't include proprietary code”, the implementation agent is provided with access to search the internet.
For the plan (e.g., within a prompt) “increase the percentage of documented code”, the implementation agent may be provided with the ability to generate text from code.
For the plan (e.g., within a prompt) “find bugs”, the implementation agent may be provided with the ability to compare specification versus implementation and may be trained on different data.
For plan (e.g., within a prompt) “increase the code coverage above the threshold”, the implementation agent maybe provided with the ability to perform automated testing and/or to suggest high-priority areas for text coverage improvement.

The implementation agent may be implemented as, for example, a GenAI model, a machine learning model, a neural network, a large language model, and the like.

The selection may be based on the type of plan, the performance indicator, and/or additional features extracted from the software development environment, for example, the code itself, the number of lines of code, programming language, operating system, kernels, running environment, and the like.

The selection may be done automatically, for example, by looking up the type of plan and/or performance indicator and/or extracted features within the metadata. The implementation agent corresponding to the metadata that includes the type of plan and/or performance indicator and/or features extracted from the software development environment, may be selected. In another example, the implementation agent may be selected by a set of rules, such as applied against the type of plan and/or performance indicator and/or features extracted from the software development environment. In yet another example, the selection may be done by a trained model (e.g., agent) that is fed the plan and/or performance indicator and/or extracted features and/or metadata, such as by generating and feeding the following prompt into the trained model “Find me a suitable implementation agent to implement the plan [insert] for improving the performance indicator [insert] of the software development environment with the following features [insert] from the set of available implementation agents found in [insert].”

The implementation agent may be implemented as, for example, a generative artificial intelligence (GenAI) model, a machine learning model, a neural network, a large language model, and the like.

The implementation agent may be trained on a training dataset of records. A record may include a sample plan, optionally a sample performance indicator(s) corresponding to the sample plan, and a ground truth of sample data elements for implementation of the plan for improvement of the sample performance indictor(s). The record may further include impact on the sample performance indicator obtained by applying the sample data elements to the software development environment. The sample data elements and/or sample performance indicator and/or the sample plan may be obtained by collecting data from real data of the software development environment, and/or by collecting data by running simulations on the software development environment. The software development environment from which data is collected for training may be the same as the current software development environment which is being improved, and/or on a similar software development environment.

In some embodiments, features described with reference to 208-214 may be integrated into a single feature. The planning agent and the implementation agent may implemented as a single combined agent. The single combined agent may be designed to automatically generate the data elements, which are predicted to improve the performance indicator(s) when implemented in the software development environment. The single combined agent may generate the data elements in response to a prompt instructing the single combined agent to improve the performance indicator. Optionally, the plan is not explicitly generated, but may be an intermediate internal step within the single combined agent, within a pipeline from the prompt to the data elements. Alternatively, the plan is generated by the single combined agent. The plan may be presented as the intermediate internal step within the pipeline. The plan may be presented on a display to a user for approval. Upon approval of the plan, the data elements may be generated.

At 214, data elements generated by the selected implementation agent are obtained.

The data elements may include, for example, values of adjustable parameters of the software development environment, instructions for execution by one or more processes (e.g., for a model that automatically generate tests to increase the number of generated tests, for another model that automatically checks code to increase the coverage of code that is checked), instructions for presenting to a developer, and the like.

The data elements may be generated in response to an input of a prompt fed into the selected implementation agent. The prompt may be generated for instructing the selected implementation agent for automatic generation for improvement of the performance indicator according to the plan, and optionally according to one or more features extracted from the development environment. For example, the prompt may be “Generate instructions for implementing the plan [insert] for improving the performance indicator [insert] of the software development environment with the following features [insert].” At 216, the data elements generated by the selected implementation agent may be implemented by (e.g., applied to) the software development environment, for example, by executing instructions, setting values of parameters, and/or running processes, according to the data elements.

An adapted software development environment is generated by implementing the data elements.

One or more adapted performance indicators may be extracted from the adapted software environment. The adapted performance indicators are different values of the original or preceding performance indicators for which the applied data elements were generated. The adapted performance indicators are predicted to narrow a gap with the corresponding guideline(s), to or meet (e.g., exceed) the corresponding guideline(s). Alternatively or additionally, the adapted performance indicator(s) are predicted to change a trend of the performance indicator(s), for example, from a negative trend to a positive trend.

Optionally, the implementation of the data elements is monitored (e.g., by monitoring code) for tracking progress and/or identifying issues.

Some examples are now provided:

In an example, the performance indicator is a percentage of code coverage by a code test. The percentage may be below a threshold defined by a best practices guideline. The planning agent designed to generate plans for the performance indicator of code coverage may be selected. The plan generated by the selected planning agent may be for increasing the code coverage above the threshold defined by the guideline. An implementation agent trained for automatically generating code tests may be selected. The implementation agent may generate instructions for automatically generating code tests for increasing the percentage of code coverage. The code tests may be automatically run by the implementation agent and/or by another agent using instructions generated by the implementation agent.

In another example, the performance indicator is a number of bugs detected per time interval. The number of bugs per time interval may be below a threshold defined by a best practices guideline. The planning agent designed to generate plans for the performance indicator of number of bugs detected per time interval may be selected. The plan generated by the selected planning agent may be for reducing the number of bugs below the threshold defined by the guideline. An implementation agent trained based on code review may be selected. The implementation agent may generate instructions for automatically reviewing code and/or for automatically improving code and/or for generating instructions for presenting to developers instructing how to review code and/or how to improve the code, is selected. The instructions may be automatically run by the implementation agent and/or by another agent using instructions generated by the implementation agent.

In yet another example, the performance indicator includes deployment frequency (DF) of successful releases of a software product to production. DF may refer to a cadence of an organization's successful releases to production. Teams may defined success differently, so deployment frequency may measure different things, for example, how often code is deployed to production, how often code is released to end users, and the like. The plan may be for increasing the deployment frequency above a threshold. The implementation agent(s) may be is trained for automatically implementing and/or configuring continuous integration/development (CI/CD) tools, which may be used to set up automated build processes, implement automated unit and integration tests, configure CI tools, automated deployment pipelines, implement infrastructure-as-code, and the like.

In yet another example, the performance indicator includes a mean lead time for changes (MLT) indicating a time from code commit to production. The plan is for decreasing the MLT below a threshold. The implementation agent(s) is trained for setting up automated code review for decreasing MLT from pull request to code merge, for example, setting up automated notifications for new pull requests, automatic assignment of reviewers based on code ownership and/or expertise, define code review guidelines, and implementing automated checks.

At 218, a presentation, optionally within a user interface, optionally a graphical user interface (GUI) may be generated and/or presented. It is to be understood that the presentation may be generated and/or presented at any features of the method described with reference to FIG. 2, optionally in parallel to one or more features of the method described with reference to FIG. 2.

Optionally, the presentation (e.g., GUI) presents one or more of: the value computed for the performance indicator, the corresponding guideline, an indication—optionally a visual indication—of whether the guideline is met by the performance indicator. For example, a gap between the performance indicator and the guideline may be shown along a scale.

The presentation may include the generated plan for improving the at least one performance indicator.

The presentation may include the generated data elements for implementing the plan.

The GUI may include one or more interactive elements for triggering respective actions, for example, a button, a clickable icon, a link, a checkbox, and the like. An example of an interactive element is for automatic execution of the plan using the selected implementation agent, i.e., approval of the plan. In another example, the interactive elements may be for approving certain components of the plan, and/or for rejecting certain components of the plan, and/or for modifying certain components of the plan, and/or for requesting other improvements of the plan. The interactive elements may enable the user to interact with the planning agent and/or implementation agent, for example, to instruct the planning and/or implementation agent to perform certain actions and/or provide additional data, for example, to increase coverage tests even at the cost of increased development time, to increase detection of bugs over improvement in complier efficiency, to access historical test cases for another software development project which are applicable to the current project, to select a different guideline to provide the target for the performance indicator, and the like. In another example, one or more potential plans may be generated. Each plan may be associated with a prediction in improvement of the performance indicator(s). The GUI may include another interactive element to enable the user to select one of the potential plans to implement. In yet another example, in response to the performance indicator not meeting or improving the corresponding guideline, an offer to assist the user by adapting the plan and/or iterating the plan and implementation thereof, may be presented. The GUI may include another interactive element to enable the user to trigger the adaptation of the plan and/or iteration of the plan and implementation thereof.

Optionally, for each respective implementation agent of the available implementation agents and/or for each planning agent of the available planning agents, one or more of the following may be presented: at least one adoption metric indicating adoption of the respective planning agent and/or implementation agent by users, and/or at least one return on investment (ROI) indicator indicating savings and/or reductions due to adoption of the respective planning agent and/or implementation agent in comparison to non-adoption of the respective planning agent and/or implementation agent.

At 220, one or more features described with reference to 203-218 may be iterated.

The features may be iterated for obtaining an adapted performance indicator(s) from the adapted software development environment. The adapted performance indicator(s) may be analyzed (e.g., evaluated) to determine whether the adapted performance indicator(s) extracted from the adapted software development environment narrowed the gap with the guideline and/or meets (e.g., exceeds) the guideline.

In response to the performance indicator(s) not sufficiently narrowing the gap and/or not meeting the guideline, and/or not changing the trend of the performance indicator(s), the iterations may proceed until the adapted performance indicator meets the corresponding guideline or sufficiently converges or the trend is changed, for example, the gap is within a suitable range and/or the gap is not further narrowing with additional iterations, the trend is changed from negative to positive.

Optionally, the presentation (e.g., GUI) is updated in each iteration, for example, to indicate the iterative improvement in the performance indicator(s), close of the gap, indication of change of trend of the performance indicator(s) (e.g., from negative to positive), prediction of when the guideline will be met, changes to the plans, and the like.

Optionally, the GUI enabling user input, as described with reference to 218, is implemented a single time, optionally during an initial iteration. Subsequent iterations may be automated, skipping the GUI enabling user input.

As the implementation agent implement the plan, the resulting actions may create measurable effects on the performance indicators. These updated performance indicators may be are captured and sent back for analysis, as described herein. The updated performance indicators and/or other data (e.g., extracted features) may be analyzed, for providing iterative feedback to inform subsequent iterations of the planning process, as described herein.

Optionally, the iterations are in a loop (e.g., step-wise, continuous), leveraging updated performance indicators and/or feedback to refine the plan, for providing incremental improvements over time.

Referring now back to FIG. 3, features of dataflow diagram 300 may be implemented by components of system 100 described with reference to FIG. 1. Features of dataflow diagram 300 may correspond to, and/or may be integrated with, and/or implemented according to, one or more features described with reference to FIG. 2.

At 302, data is provided. The data may be associated with, and/or obtained from, a software development environment. Examples of data include performance indicators, guidelines, metadata, and/or extracted features. The data may include context, which may be automatically obtained by the implementation agent(s). Additional details of exemplary data is described, for example, with reference to 204 and/or 206 of FIG. 2.

The data may be fed into a system 304, for example, computing environment 104 described with reference to FIG. 1.

A plan 307 may be generated 306 using the data, such as based on an analysis of the data, for example, as described with reference to 206 and/or 210 of FIG. 2. The plan 307 may be generated using a selected planning agent 308, which may be selected from available planning and/or implementation agents 310 according to corresponding tags 311, for example, as described with reference to 208 of FIG. 2.

The generated plan 307 may be provided for a user feedback 312, for example, presented on a display such as within a GUI, for example, as described with reference to 218 of FIG. 2.

The plan 307 may be modified 314, optionally by the user via the GUI (e.g., providing user feedback) 312, for example, as described with reference to 218 of FIG. 2. Plan 307 may be iteratively adapted according to user feedback 312 (e.g., provided via the GUI).

The plan 307, optionally the modified plan, is executed 316, i.e., implemented within a software development environment 318. The plan 307 is executed by one or more selected implementation agents 317, which may be selected, for example, as described with reference to 212 of FIG. 2. The plan 307 may be executed by obtaining data elements 320 from the implementation agent(s) 317, and applying the data elements 320 to the software development environment 318, for example, as described with reference to 214-216 of FIG. 2.

Context 322 may be obtained from software development environment 318, for example, by the selected implementation agent(s) 317 and/or the planning agent(s) 308. The context 322 may be used for generation of plan 307 and/or for instructing implementation agent(s) 317.

At 324, the effect of executing the plan may be measured, such as by computing changes to the performance indicators to determine whether the gap with the guideline is closing and/or whether the trend of the performance indicator(s) is changing (e.g., from negative to positive), for example, as described with reference to 220 of FIG. 2.

In one or more iterations, the effect of executing the plan is used for generating an adapted plan, which may improve the performance indicator for further closing the gap and/or for meeting the guideline and/or for changing the trend, for example, as described with reference to 220 of FIG. 2.

Referring now back to FIG. 4, GUIs 402A-B may be implemented as, for example, described with reference to 218 of FIG. 2, and/or by components of system 100 described with reference to FIG. 1.

GUI 402A presents a graph of the performance indicator of code coverage 404A over a historical time interval, relative to an industry standard threshold 406A (e.g., 70%). Code coverage graph 404A indicates that the code coverage is below industry standard threshold 406A. An insight 408A based on an analysis of the code coverage relative to the threshold may be presented. GUI 402A may present one or more plans 410A, which may be generated as described herein. The user may select one or more of plans, for example, by selecting a checkbox. GUI 402A may include an option 411A for the user to chat with an agent to iterate on one or more proposed plans, for example, to obtain a different plan more suitable to the user. The user may chat, for example, with the planning agent, and/or with a LLM model designed to interact with the planning agent, such as designed to generate the prompt for the planning agent. GUI 402A may include an interactive element 412A such as a submit button, that triggers implementation of the selected plans, such as by clicking. Interactive element 412A may be used to indicate approval of the selected plan.

GUI 402B presents another graph of another performance indicator of number of bugs per month 404B, relative to an industry standard threshold 406B (e.g., 8 bugs per month). Graph 404B indicates a negative trend relative to industry standard threshold 406B. An insight 408B based on an analysis of a trend of the number of bugs per month relative to the threshold may be presented. GUI 402B may present one or more plans 410B, which may be generated as described herein. The user may select one or more of plans, for example, by selecting a checkbox. GUI 402B may include an option 411B for the user to chat with an agent to iterate on one or more proposed plans, for example, to obtain a different plan more suitable to the user. The user may chat, for example, with the planning agent, and/or with a LLM model designed to interact with the planning agent, such as designed to generate the prompt for the planning agent. GUI 402B may include an interactive element 412B such as a submit button, that triggers implementation of the selected plans, such as by clicking. Interactive element 412B may be used to indicate approval of the selected plan.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models will be developed and the scope of the term machine learning model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer-implemented method of automatically improving software development efficiency, comprising using at least one processor for:
accessing a software development environment in a process of developing software;
extracting at least one performance indicator from the software development environment, wherein the at least one performance indicator comprises measurable metrics related to software development efficiency;
obtaining context of the software development environment;
analyzing the at least one performance indicator with respect to a corresponding at least one guideline stored on a data storage device;
in response to the at least one performance indicator not meeting the corresponding at least one guideline:
automatically generating, by a machine learning based planning agent selected from a plurality of specialized planning agents according to the at least one performance indicator, a plan for improving the at least one performance indicator based on the context,
automatically selecting at least one machine learning based implementation agent from a plurality of specialized machine learning based implementation agents based on the plan,
generating a prompt for instructing the selected at least one implementation agent for automatic generation for improvement of the at least one performance indicator according to the plan, wherein the prompt includes the context,
feeding the prompt into the selected at least one implementation agent,
obtaining data elements generated by the selected at least one implementation agent in response to the prompt; and
applying the data elements generated by the selected at least one machine learning based implementation agent to the software development environment to generate an adapted software development environment, wherein the adapted software development environment with at least one adapted performance indicator improves software development efficiency by narrowing a gap with or meeting the corresponding at least one guideline, and/or changing a trend of the at least one performance indicator.

2. The computer implemented method of claim 1, further comprising re-executing the extracting and the analyzing for obtaining an adapted at least one performance indicator from the adapted software development environment, and evaluating whether the adapted at least one performance indicator extracted from the adapted software development environment narrowed the gap and/or meets the at least one guideline, and/or a trend of the at least one performance indicator is changed.

3. The computer implemented method of claim 2, further comprising iterating the extracting, the analyzing, the in response, and the applying, until the at least one adapted performance indicator meets the corresponding at least one guideline, or converges, or another preset condition is met.

4. The computer implemented method of claim 1, wherein the at least one performance indicator includes a percentage of code coverage by a code test, the plan is for increasing code coverage above a threshold defined by the at least one guideline, and the at least one implementation agent is trained for automatically generating code tests for increasing the percentage of code coverage.

5. The computer implemented method of claim 1, wherein the at least one performance indicator includes a number of bugs detected per time interval, the plan is for reducing the number of bugs below a threshold defined by the at least one guideline, and the at least one implementation agent is trained for automatically reviewing code and/or for automatically improving code and/or for generating instructions for presenting to developers instructing how to review code and/or how to improve the code.

6. The computer implemented method of claim 1, wherein the at least one performance indicator includes deployment frequency of successful releases of a software product to production, the plan is for increasing the deployment frequency above a threshold, and the at least one implementation agent is trained for automatically implementing and/or configuring continuous integration/development (CI/CD) tools.

7. The computed implemented method of claim 1, wherein the at least one performance indicator includes a mean lead time for changes (MLT) indicating a time from code commit to production, the plan is for decreasing the MLT below a threshold, and the at least one implementation agent is trained for setting up automated code review for decreasing MLT from pull request to code merge.

8. The computer implemented method of claim 1, wherein the software development environment is hosted by a computing environment, and includes at least one of: written code, automatically generated code, test plans, version control tools and ci/cd tools, specification, and output logs.

9. The computer implemented method of claim 1, further comprising:
obtaining a plurality of the at least one performance indicator over a historical time interval,
predicting whether the at least one performance indicator will not meet the at least one guideline in the future based on a trend analysis of the plurality of the at least one performance indicator over the historical time interval, and
wherein the plan is for at least one of: improving the prediction of the at least one performance indicator for meeting the at least one guideline in the future.

10. The computer implemented method of claim 1, further comprising:
generating a graphical user interface (GUI) for presentation on a display, the GUI presenting at least one of: the at least one performance indicator, the corresponding at least one guideline, and a visual indication of whether the at least one guideline is met by the at least one performance indicator,
the GUI further including an interactive element for triggering the automatic execution of the plan using the selected at least one implementation agent.

11. The computer implemented method of claim 10, wherein in response to the at least one performance indicator not meeting or improving the corresponding at least one guideline, presenting an offer to assist the user by adapting the plan and/or iterating the plan and implementation thereof, and the GUI further includes at least one second interactive element to enable the user to trigger the adaptation of the plan and/or iteration of the plan and implementation thereof.

12. The computer implemented method of claim 1, further comprising for each respective planning agent of the plurality of planning agents, presenting at least one of: at least one adoption metric indicating adoption of the respective planning agent by users, and/or at least one return on investment (ROI) indicator indicating savings and/or reductions due to adoption of the respective planning agent in comparison to non-adoption of the respective planning agent.

13. The computer implemented method of claim 1, wherein the at least one performance indicator includes key development metrics indicating development efficiency and/or quality, comprising at least one of: DORA (DevOps Research and Assessment) metrics, code coverage, defect rates, and cycle time.

14. The computer implemented method of claim 1, wherein automatically generating the plan comprises automatically generating at least one plan for improving the at least one performance indicator, and further comprising:
presenting the at least one automatically generated plan on a display within a GUI,
wherein the GUI includes at least one interactive element for enabling a user to select the plan from the at least one automatically generated plan,
wherein the plan is selected by the user using the at least one interactive element.

15. The computer implemented method of claim 1, at least one of: (1) wherein each respective implementation agent is associated with a first tag indicating at least one performance indicator that the respective implementation agent generates data elements for improvement thereof, the first tag used for selecting the implementation agent, and (2) wherein each respective planning agent is associated with a second tag indicating at least one performance indicator that the respective planning agent may generate a plan for improvement of, the second tag used for selecting the planning agent.

16. The computer implemented method of claim 1, at least one of: (1) wherein each planning agent is associated with a respective set of tools and/or resources designed to perform specific tasks for generating a plan for a corresponding performance indicator, and (2) wherein each implementation agent is associated with a respective set of tools and/or resources designed to perform specific tasks for generating data elements for improving the corresponding performance indicator.

17. The computer implemented method of claim 1, further comprising:
extracting a plurality of features from the software development environment;
determining a cause-effect relationship between changes to the plurality of features and impact on the at least one performance indicator;
predicting the changes to the plurality of features for closing a gap between the at least one performance indicator and the at least one guideline according to the cause-effect relationship; and
selecting the planning agent and/or at least one implementation agent predicted to change the plurality of features for closing the gap.

18. The computer implemented method of claim 1, wherein the planning agent and the at least one implementation agent are implemented as a single combined agent, that automatically generates data elements predicted to improve the at least one performance indicator when implemented in the software development environment, in response to a prompt instructing the single combined agent to improve the at least one performance indicator.

19. The computer implemented method of claim 1, wherein the at least one implementation agent and/or the planning agent automatically retrieves context of the software development environment according to the at least one performance indicator and/or according to the prompt.

20. A system for automated support of software development, comprising: at least one hardware processor executing a code for:
accessing a software development environment in a process of developing software;
extracting at least one performance indicator from the software development environment;
obtaining context of the software development environment;
analyzing the at least one performance indicator with respect to a corresponding at least one guideline;
in response to the at least one performance indicator not meeting the corresponding at least one guideline:
automatically generating a plan for improving the at least one performance indicator according to the context by a planning agent selected from a plurality of planning agents according to the at least one performance indicator,
automatically selecting at least one implementation agent from a plurality of implementation agents based on the plan,
generating a prompt for instructing the selected at least one implementation agent for automatic generation for improvement of the at least one performance indicator according to the plan, wherein the prompt includes the context,
feeding the prompt into the selected at least one implementation agent,
obtaining data elements generated by the selected at least one implementation agent; and
applying the data elements generated by the selected at least one implementation agent to the software development environment to generate an adapted software development environment with at least one adapted performance indicator for narrowing a gap with or meeting the corresponding at least one guideline.

21. A non-transitory medium storing program instructions for automated support of software development, which when executed by at least one processor, cause the at least one processor to:
access a software development environment in a process of developing software;
extract at least one performance indicator from the software development environment;
obtain context of the software development environment;
analyze the at least one performance indicator with respect to a corresponding at least one guideline;
in response to the at least one performance indicator not meeting the corresponding at least one guideline:
automatically generating a plan for improving the at least one performance indicator according to the context by an planning agent selected from a plurality of planning agents according to the at least one performance indicator,
automatically selecting at least one implementation agent from a plurality of implementation agents based on the plan,
generating a prompt for instructing the selected at least one implementation agent for automatic generation for improvement of the at least one performance indicator according to the plan, wherein the prompt includes the context,
feeding the prompt into the selected at least one implementation agent,
obtaining data elements generated by the selected at least one implementation agent; and
apply the data elements generated by the selected at least one implementation agent to the software development environment to generate an adapted software development environment with at least one adapted performance indicator for narrowing a gap with or meeting the corresponding at least one guideline.
